(19) United States
(12) Patent Application Publication
(10) Pub. No.: US 2013/0050815 A1
(43) Pub. Date: Feb. 28, 2013

(54) THREE-DIMENSIONAL IMAGE DISPLAY APPARATUS

(71) Applicants: Rieko FUKUSHIMA, Tokyo (JP); Yuzo Hirayama, Yokohama-shi (JP); Shinichi Uehara, Tokyo (JP); Masahiro Baba, Yokohama-shi (JP)

(72) Inventors: Rieko FUKUSHIMA, Tokyo (JP); Yuzo Hirayama, Yokohama-shi (JP); Shinichi Uehara, Tokyo (JP); Masahiro Baba, Yokohama-shi (JP)

(21) Appl. No.: 13/403,045

(22) Filed: Feb. 23, 2012

(30) Foreign Application Priority Data
Aug. 29, 2011 (JP) 2011-186598

(51) Int. Cl. G02B 27/22

(52) U.S. Cl. 359/462

(57) ABSTRACT

According to an embodiment, there is provided a 3D image display apparatus provided with a display unit and a control element arranged to oppose the display unit. The control element has a number of optical apertures linearly extended and tilted at an angle θ with respect to a linearly extending direction. The sub-pixel have one of first and second patterns defined by an aperture and a light-shielding portion. The sub-pixels of an identical color are arrayed to alternately have the first and second patterns or the second and first patterns along the second direction, and the sub-pixels are arrayed so as to mutually give at least one of no line-symmetry relationship and no point-symmetry relationship.

### CROSS-REFERENCE TO RELATED APPLICATIONS

This application is based upon and claims the benefit of priority from prior Japanese Patent Application No. 2011-186598, filed Aug. 29, 2011, the entire contents of which are incorporated herein by reference.

### FIELD

Embodiments described herein relate generally to a three-dimensional image display apparatus for displaying a three-dimensional image.

### BACKGROUND

As a three-dimensional (3D) image display apparatus which can display a moving image, that is, a so-called 3D display, various systems are known. In recent years, especially, a system which adopts a flat-panel type, and does not require any dedicated glasses is strongly demanded. As one 3D image display apparatus of a type which does not require any dedicated glasses, a system in which a ray control element is arranged immediately in front of a display panel (i.e., display device) whose pixel positions are fixed like a direct-viewing or projection type liquid crystal display device or plasma display device, and rays coming from the display panel are controlled to be directed toward a viewer is known. The ray control element gives a function that allows the viewer to view different images depending on viewing angles even when he or she views an identical position on the ray control element.

Such 3D image display system using the ray control element is classified into a binocular system (or a two view system), multi-view system, ultra-multi-view system (ultra-multi-view conditions of the multi-view system), integral imaging (to be also referred to as “II” hereinafter) system, and the like depending on the number of parallaxes (visual differences when viewed from different directions) and design guides. The two-view system attains stereoscopic viewing based on a binocular parallax, but since other systems can attain motion parallaxes on one level or another, they are called 3D images to be distinguished from stereoscopic images of the two-view system. The basic principle required to display these 3D images is substantially the same as that of integral photography (IP) which was invented about 100 years ago and is applied to 3D photographs.

Of these systems, the II system features that degrees of freedom of viewpoint positions are enhanced by increasing parallax presenting directions to allow stereoscopic viewing over a relatively broad range. The parallax presenting directions can be increased according to the number of pixels corresponding to optical apertures. However, since the optical apertures are directly involved in the resolution of a 3D image, the resolution tends to lower when a display device of an identical resolution is used. For this reason, in a one-dimensional (1D) II system, the parallax presenting direction is limited to a horizontal direction to implement a display device with a high resolution, as described in non-patent literature 1. On the other hand, in the binocular system (i.e., the two view system) or multi-view system, viewpoint positions that allow stereoscopic viewing are limited, and stereoscopic viewing at positions other than the viewpoint position is resigned to decrease the parallax presenting directions. Therefore, in the binocular system or multi-view system, the resolution can be enhanced relatively easily compared to the 1D II system. Since a 3D image can be generated by only images acquired from the viewpoint positions, a load required to generate images can be reduced. However, since the viewpoint positions are limited, it is difficult to view 3D images for a long period of time.

In such direct-view, naked-eye 3D display apparatus using optical apertures, moiré or false color is generated due to optical interferences between a one-dimensional periodic structure of optical apertures, and light-shielding portions which partition pixels arranged in a matrix on a flat-panel display device, or a periodic structure in the horizontal direction (first direction) of color arrays of pixels. As a measure against such moiré or false color, there are disclosed a method of devising a layout of the light-shielding portions of pixels, in Japanese Patent 3525995 and Japanese Patent 4197716 and JP-A. 2008-249887 (KOKAI). However, as disclosed in, for example, Japanese Patent 3940725, in a system in which a high-definition two-dimensional (2D) display is attained even in a state without any ray control element by electrically turning on/off the ray control element, it is desired to maintain original display quality even in the state without any ray control element. In such case, a method of forming an angle between the periodicities of the ray control element and pixels, that is, a method of tilting optical apertures, is known, as disclosed in U.S. Pat. No. 6,064,424. However, it is revealed that only tilt control cannot perfectly eliminate moiré. As disclosed in JP-A. 2005-86414 (KOKAI), a method of eliminating moiré by adding diffuse components can be adopted. However, since this method worsens separation of parallax information, an image quality drop cannot be avoided.

As described above, in a conventional 3D image display apparatus which combines a ray control element having a periodicity limited to one direction, and a flat-panel display device on which pixels are two-dimensionally arrayed, periodicities of the optical apertures which are arranged periodically and pixels of the flat-panel display device interfere with each other, thus generating luminance non-uniformity (moiré). A method of suppressing moiré by controlling the relationship between the periodicities of optical apertures and pixels by adjusting the angle of the optical apertures is known. However, with only this method, moiré cannot often be sufficiently eliminated, and it is revealed that a problem is posed when pixels do not have a single aperture shape.

### BRIEF DESCRIPTION OF THE DRAWINGS

FIG. 1 is a schematic perspective view showing a 3D image display apparatus according to an embodiment;

FIG. 2 is an explanatory view according to the first comparative example used to explain pixel arrays, and is a schematic plan view showing a partial pixel array viewed on the 3D image display apparatus shown in FIG. 1;

FIG. 3 is a partial horizontal sectional view of the 3D image display apparatus to schematically show ray loci from pixels, which pass through an optical aperture in the 3D image display apparatus shown in FIG. 1, and is a horizontal sectional view explanatorily showing a change of pixels to be viewed depending on viewing positions;

FIG. 4 is a graph showing luminance characteristics according to the first comparative example used to explain changes in luminance to be viewed via an optical aperture depending on viewing positions in the 3D image display apparatus shown in FIG. 1;

FIG. 5 is an explanatory view according to the second comparative example used to explain pixel arrays, and is a partial schematic plan view showing a partial pixel array viewed in the 3D image display apparatus shown in FIG. 1;

FIG. 6 is a graph showing luminance characteristics according to the second comparative example used to explain changes in luminance to be viewed via an optical aperture depending on viewing positions in the 3D image display apparatus shown in FIG. 1;

FIG. 7 is a view for explaining patterns of sub-pixels which configure a pixel and are formed line-symmetrically in the 3D image display apparatus shown in FIG. 1;

FIG. 8 is a view for explaining patterns of sub-pixels which configure a pixel and are formed point-symmetrically in the 3D image display apparatus shown in FIG. 1;

FIG. 9 is an explanatory view for explaining sub-pixel arrays according to the third comparative example in the 3D image display apparatus shown in FIG. 1, and is a schematic plan view of some pixel arrays on which sub-pixels of two different types are arranged in a checkered pattern;

FIG. 10 is a plan view showing a moiré pattern viewed in the 3D image display apparatus which uses a display device having the pixel arrays according to the third comparative example shown in FIG. 9;

FIG. 11A is a schematic plan view of one column of the pixel array according to the third comparative example shown in FIG. 9, which is extracted and tilted, so that an optical aperture of a ray control element agrees with a certain coordinate axis Y, for example, a vertical direction Y;

FIG. 11B is a graph showing luminance changes depending on an X direction, which are calculated by arranging results obtained by searching the optical aperture shown in FIG. 11A in the Y direction and summing up the search results in the X direction as a normal direction to the optical aperture;

FIG. 12 is a graph showing a frequency distribution calculated by Fourier-transforming the luminance distribution according to the third comparative example shown in FIG. 11B;

FIG. 13 is a schematic plan view showing some pixel arrays configured by sub-pixels of a first pattern alone so as to explain sub-pixel arrays according to the fourth comparative example in the 3D image display apparatus shown in FIG. 1;

FIG. 14 is a plan view showing a moiré pattern viewed in the 3D image display apparatus using a display device having the pixel arrays according to the fourth comparative example shown in FIG. 10;

FIG. 15A is a schematic plan view of one column of the pixel array according to the fourth comparative example shown in FIG. 10, which is extracted and tilted so that one optical aperture of a ray control element agrees with the vertical direction Y;

FIG. 15B is a graph showing luminance changes depending on the X direction, which are calculated by arranging results obtained by searching the optical aperture shown in FIG. 15A in the Y direction and summing up the search results in the X direction as a normal direction to the optical aperture;

FIG. 16 is a graph showing a frequency distribution calculated by Fourier-transforming the luminance distribution according to the fourth comparative example shown in FIG. 15B;

FIG. 17 is a schematic plan view showing some pixel arrays in which sub-pixels of two different types are arranged in a checkered pattern, and a layout of some light-shielding portions is changed, so as to explain sub-pixel arrays according to the first embodiment in the 3D image display apparatus shown in FIG. 1;

FIG. 18 is a plan view showing a moiré pattern viewed in the 3D image display apparatus using a display device having the pixel arrays according to the first embodiment shown in FIG. 17;

FIG. 19A is a schematic plan view of one column of the pixel array according to the first embodiment shown in FIG. 17, which is extracted and tilted so that one optical aperture of a ray control element agrees with the vertical direction Y;

FIG. 19B is a graph showing luminance changes depending on the X direction, which are calculated by arranging results obtained by searching the optical aperture shown in FIG. 19A in the Y direction and summing up the search results in the X direction as a normal direction to the optical aperture;

FIG. 20 is a graph showing a frequency distribution calculated by Fourier-transforming the luminance distribution according to the first embodiment shown in FIG. 19B;

FIG. 21 is a schematic plan view showing some pixel arrays in which sub-pixels of two different types are arranged in a checkered pattern, light-shielding portions are partially added, and a layout of the light-shielding portions is changed to lose symmetry, so as to explain sub-pixel arrays according to the second embodiment in the 3D image display apparatus shown in FIG. 1;

FIG. 22 is a plan view showing a moiré pattern viewed in the 3D image display apparatus using a display device having the pixel arrays according to the second embodiment shown in FIG. 21;

FIG. 23A is a schematic plan view of one column of the pixel array according to the second embodiment shown in FIG. 21, which is extracted and tilted so that one optical aperture of a ray control element agrees with the vertical direction Y;

FIG. 23B is a graph showing luminance changes depending on the X direction, which are calculated by arranging results obtained by searching the optical aperture shown in FIG. 23A in the Y direction and summing up the search results in the X direction as a normal direction to the optical aperture;

FIG. 24 is a graph showing a frequency distribution calculated by Fourier-transforming the luminance distribution according to the second embodiment shown in FIG. 23B;

FIG. 25 is a schematic plan view showing some pixel arrays in which sub-pixels of two different types are arranged in a checkered pattern, light-shielding portions are partially added, and a layout of the light-shielding portions is changed to lose symmetry, so as to explain sub-pixel arrays according to the third embodiment in the 3D image display apparatus shown in FIG. 1;

FIG. 26 is a plan view showing a moiré pattern viewed in the 3D image display apparatus using a display device having the pixel arrays according to the third embodiment shown in FIG. 25;

FIG. 27A is a schematic plan view of one column of the pixel array according to the third embodiment shown in FIG. 25, which is extracted and tilted so that one optical aperture of a ray control element agrees with the vertical direction Y;

FIG. 27B is a graph showing luminance changes depending on the X direction, which are calculated by arranging results obtained by searching the optical aperture shown in FIG. 27A in the Y direction and summing up the search results in the X direction as a normal direction to the optical aperture; and

FIG. 28 is a graph showing a frequency distribution calculated by Fourier-transforming the luminance distribution according to the third embodiment shown in FIG. 27B.

### DETAILED DESCRIPTION

Various embodiments will be described hereinafter with reference to the accompanying drawings.

In general, according to one embodiment, there is provided a 3D image display apparatus which includes a display unit having pixels which are arrayed in a matrix at a pixel period pp along a first direction and a second direction perpendicular to the first direction, and each pixel is configured by a plurality of sub-pixels which display different colors. A ray control element is arranged to oppose this display unit. The ray control element is configured by a large number of optical apertures which are linearly extended to be tilted so as to form a certain angle θ with the second direction, and are arrayed along a direction perpendicular to this extending direction.

In the 3D image display apparatus according to this embodiment, the sub-pixel is configured to have one of first and second patterns, formed by an aperture which displays a color of that sub-pixel, and a light-shielding portion which defines the aperture. The sub-pixels of an identical color are arrayed to alternately have the first and second patterns or the second and first patterns along the second direction, and the sub-pixels are arrayed in a matrix so as not to mutually give a line-symmetry or point-symmetry relationship.

In the 3D image display apparatus according to this embodiment, the optical apertures are obliquely laid out, and pixel shapes are modified. As a result, moiré can be eliminated, and image quality of 3D images can be improved.

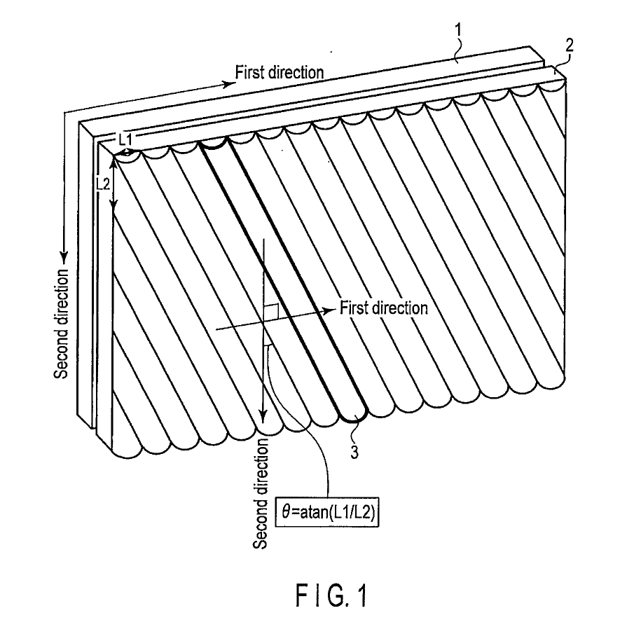

FIG. 1 is a schematic perspective view showing a 3D image display apparatus according to a more practical embodiment. A ray control element 2 is laid out on the front surface of a flat-panel display device 1. On this ray control element 2, optical apertures 3 (cylindrical lenses in this case) are laid out along a first direction, for example, a horizontal direction, and are extended to form a certain angle θ with a second direction, for example, a vertical direction, perpendicular to this first direction. More specifically, a horizontal pitch (first direction pitch) of the optical apertures 3 (for example, cylindrical lenses) is set to be L1 [pp] and a vertical pitch (second direction pitch) is set to be L2 [pp]. The extending direction of the optical apertures 3 (ridge direction of the cylindrical lenses) is extended to form an angle θ=arctan (L1/L2) with the second direction. The optical apertures 3 are periodically laid out at the pitch L1 [pp] in the first direction, for example, the horizontal direction.

When the ray control element 2 gives only a right-and-left parallax (horizontal parallax), optical apertures such as slits (parallax barriers) or cylindrical lenses are periodically laid out in a one-dimensional direction. Such ray control element is called a barrier or lenticular lens.

Note that this embodiment will practically describe the ray control element using the cylindrical lenses. Alternatively, the ray control element 2 may be configured by an optical element including liquid crystal lenses. Such optical element can generate a large number of liquid crystal lenses in itself. That is, the optical element can generate the liquid crystal lenses as needed only when a 3D image is displayed, and can clear these liquid crystal lenses when a 2D image is displayed. Therefore, a display device which can selectively display 2D and 3D images can be implemented. In the optical element including the liquid crystal lenses and the like, a refractive index of liquid crystal in the optical element is changed according to a voltage to be applied, so as to generate, for example, the liquid crystal lenses similar to cylindrical lenses in the ray control element 2, thereby controlling liquid crystal rays.

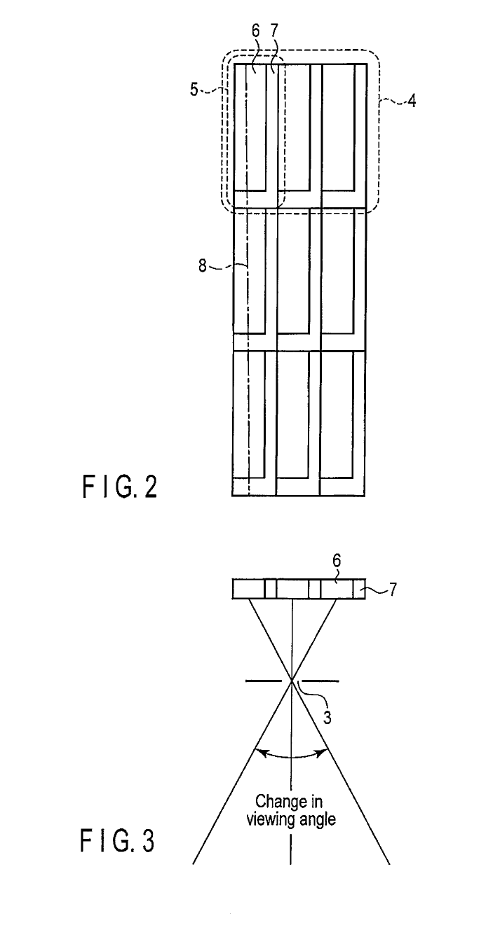

FIG. 2 is an explanatory view of pixel arrays, and is a partially enlarged schematic view of an array of pixels 4 along the second direction of the flat-panel display device 1 shown in FIG. 1. A display surface of the flat-panel display device 1 is configured by laying out the pixels 4 in a matrix at a pixel pitch pp in the horizontal and vertical directions (first and second directions). Each pixel 4 is configured by sub-pixels 5 arrayed along the horizontal direction (first direction). Each sub-pixel 5 is configured by a pixel aperture 6 which allows rays to transmit through it, and a pixel light-shielding portion 7 which shields rays. In general, each pixel 4 is formed to have a nearly square shape (a square of pp×pp) by sub-pixels having R (red), green (G), and blue (B) filter functions since its pixel region is divided into three segments in the horizontal direction. Therefore, each sub-pixel 1 is formed to be a rectangle in which lengths of the adjacent sides are 1:3. Rays coming from a backlight (not shown) laid out on the back surface of the flat-panel display device 1 are output toward the front side of the display unit as those of one of RGB colors when they pass through this pixel aperture 6. These rays are converted into those, exit directions of which are controlled, when they pass through the optical apertures 3 of the ray control element 2, and are then projected toward the front side, thus displaying a 3D image.

In such 3D image display apparatus, since the sub-pixels 5 are laid out to have periodicities with respect to the optical apertures 3, a viewer who views a 3D image unwantedly views moiré based on interferences of periodicities. In this embodiment, based on the knowledge of the inventors, moiré can be suppressed by designing shapes of the pixel apertures 6 of the sub-pixels so as to give a line-symmetry or point-symmetry relationship when the shapes of the pixel apertures 6 of the sub-pixels have two or more types. Generation of moiré will be explained below with reference to the first to third comparative examples shown in FIGS. 2, 3, 4, 5, 6, 7, and 8, so as to help better understanding of this embodiment, which is optimal to moiré suppression.

### First Comparative Example

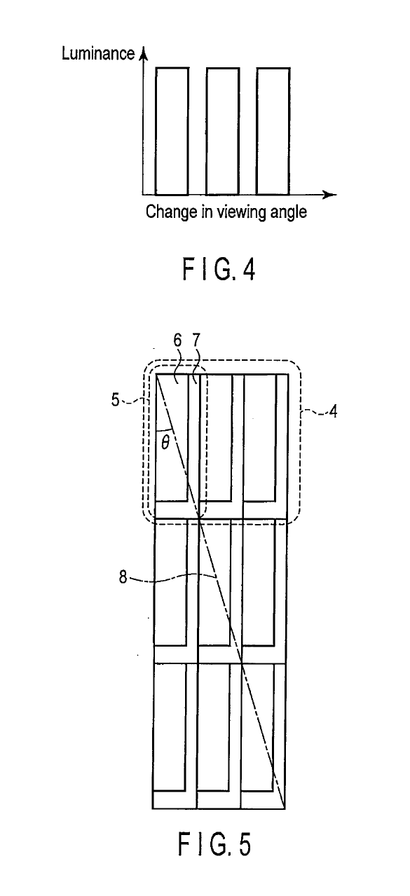

FIG. 2 shows an optical layout in which a ridge 8 of the optical aperture 3 (an axial line or center line of the optical aperture 3) agrees with the second direction (vertical direction) as an example of a simple optical system that causes moiré (first comparative example). In this case, FIG. 2 shows a broken line which indicates the ridge 8 (the axial line or center line of the optical aperture 3) viewed on the pixels 4 when the optical aperture 3 is viewed from a certain direction (certain angle). In such optical layout, as shown in the horizontal sectional view of FIG. 3, a ray emanating from the pixel 4 is output toward the front side of the display device since its exit direction is controlled when that ray passes through the optical aperture 3. From another point of view, this control means that positions to be viewed on the pixels 4 are shifted via the optical apertures 3 according to a change in viewing position (a change in viewing angle), only pixels which display parallax information to be seen are viewed from the changed position. Since each pixel 4 has the light-shielding portions 7, as described above, a luminance level is changed to have periodicities depending on the viewing angle, as shown in FIG. 4. This luminance level is set depending on a total of aperture heights of the pixel apertures 6 (the lengths of the apertures in the vertical direction as the second direction) at a position of the first direction (horizontal direction). When the light-shielding portions 7 continuously appear on the second direction (vertical direction) at a certain position of the first direction (horizontal direction), the total value of the aperture heights becomes zero, and a luminance level also becomes zero. On the other hand, when the pixel apertures 6 are arrayed on the second direction (vertical direction) at another position of the first direction (horizontal direction), the total value of the aperture heights becomes large, resulting in a high luminance level. As can be seen from FIG. 4, in the optical layout in which the extending direction of each optical aperture 3 agrees with the second direction, a linear region on a certain position of the first direction (horizontal direction) is viewed depending on the viewing angle. When only the light-shielding portions 7 are viewed (the total value of the aperture heights is zero), the luminance level also becomes zero. When the apertures 6 are viewed (when the total value of the aperture heights is increased), the luminance level is also increased, thus consequently causing periodic luminance changes as the viewing angle is changed. Therefore, as shown in FIG. 4, with the optical layout according to the first comparative example shown in FIG. 2, the viewer recognizes moiré based on the periodic luminance changes.

### Second Comparative Example

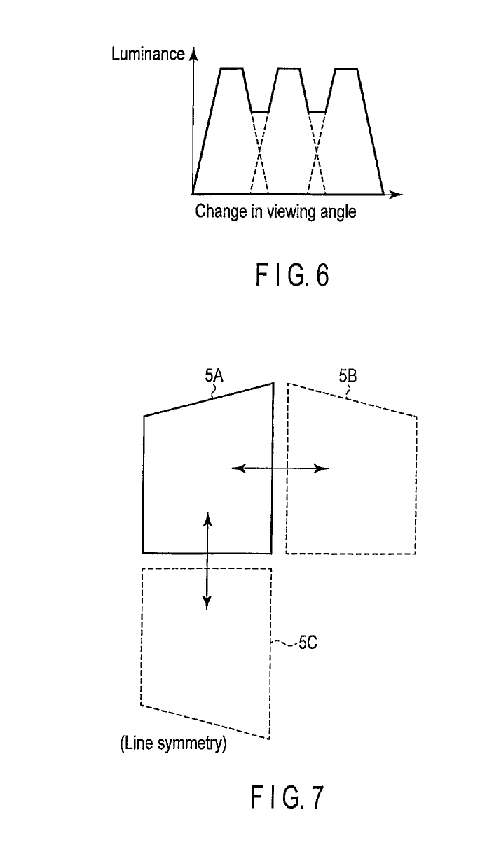

FIG. 5 shows an optical layout (second comparative example) in which an angle θ that the ridge 8 of the optical aperture 3 makes with the vertical direction in which the pixels 4 of the display unit are arrayed is set to be θ=arctan(⅓). Since the angle θ is given, variations of ratios of the pixel apertures 6 which can be seen via the ray control element 2 are suppressed, as shown in FIG. 6. However, even in this optical layout (second comparative example), luminance changes are still large, and cannot reach a practical level (product level) range. More specifically, it is pointed out that luminance changes are in phase in all rows, and the luminance changes shown in FIG. 6 are visually recognized as those in a plane or according to a viewing position, that is, as moiré.

In order to prevent moiré, it is required to calculate conditions that in-plane luminance levels of the 3D display apparatus are constant independently of the viewing angles when luminance change phases for respective rows to be viewed via each optical aperture 3 are shifted, and phases for the respective optical apertures 3 are shifted, that is, the tilt and pitch of the optical apertures 3 are controlled. In this case, a detailed description of the conditions is not given.

As described above, it is revealed that moiré cannot be eliminated even by adjusting the angle of the optical apertures 3 in some cases. More specifically, it is apparent that when a liquid crystal display of a TN (Twist Nematic) mode having only one type of an aperture shape of the pixels 4 is used as the display device 1, even when the ray control element 2 is designed to have the calculated angle θ that can eliminate moiré, moiré is generated in a VA (Vertical Alignment) mode or IPS mode.

As can be seen from the aforementioned results, adjustments of the tilt and pitch of the optical apertures 3 of the ray control element 2 are effective to suppress luminance nonuniformity (moiré), but moiré cannot be perfectly eliminated by only such measures. The present inventor considers a cause of this problem, as will be described below with reference to FIGS. 7, 8, 9, 10, 11A, 11B, 12, 13, 14, 15A, 15B, and 16.

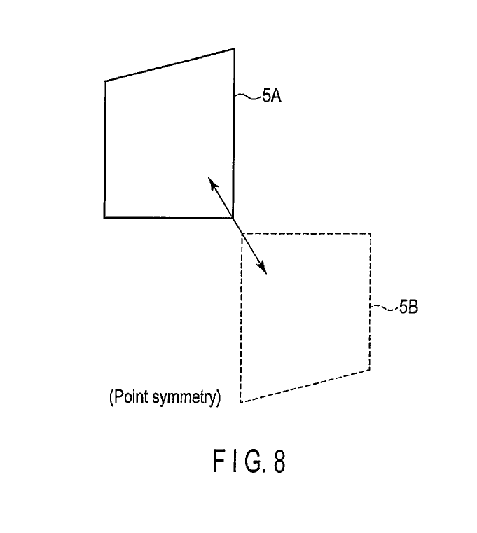

In a VA (Vertical Alignment) mode of a flat-panel display device (especially, a liquid crystal display device), the sub-pixels 5 having two or more different shapes are often designed for the purpose of eliminating asymmetry of viewing angle characteristics. In general, a method of designing an aperture shape of a certain sub-pixel 5A, and designing sub-pixels 5B and 5C having aperture shapes different from that of the sub-pixel 5A to be line-symmetric to this sub-pixel 5A (FIG. 7), or a method of designing a sub-pixel 5B having an aperture shape different from that of the sub-pixel 5A to be point-symmetric to the sub-pixel 5A in place of line symmetry (FIG. 8) is adopted. More specifically, as shown in FIG. 7, sub-pixels 5B and 5C of an identical color, which neighbor a certain sub-pixel 5A in the row and column directions, are designed to have aperture shapes which are line-symmetric to that of the sub-pixel 5A. In the example shown in FIG. 8, a sub-pixel 5B of an identical color, which neighbors a certain sub-pixel 5A in the row and column directions, is designed to have an aperture shape point-symmetric to that of the sub-pixel 5A.

In this specification, the aperture shape of the certain sub-pixel 5A will be referred to as a first pattern (reference pattern) since it corresponds to a reference pattern, and the aperture shape of each of the sub-pixels 5B and 5C which are line- or point-symmetric to the reference pattern will be referred to as a second pattern (symmetric pattern) since it is different from the reference pattern.

As is known in the field of display devices, a pixel design associated with combinations of the first and second patterns is made, and sub-pixels 5B and 5C having apertures of the second pattern and sub-pixels 5A having apertures of the first pattern are alternately laid out in combination, for example, in a checkered pattern, thus eliminating the asymmetry of the viewing angle characteristics. However, since such pixel design generates periodicities longer than a sub-pixel pitch, new interferences (moiré), that is, luminance changes, are generated due to the newly generated periodicities.

### Third Comparative Example

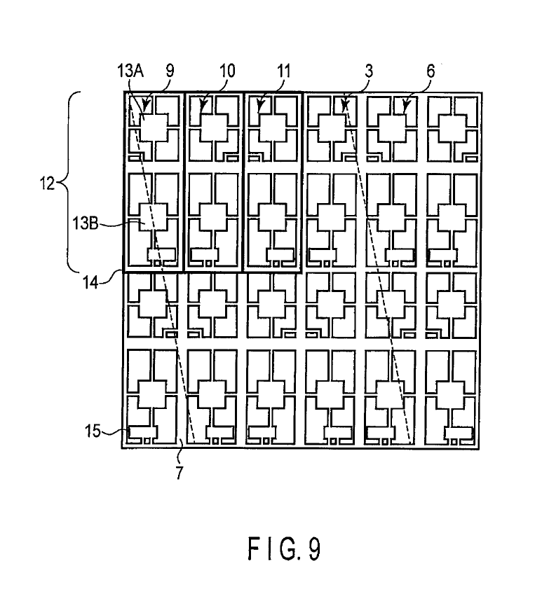

FIG. 9 shows the relationship between sub-pixel arrays and the optical apertures 3 of the ray control element 2 in a certain liquid crystal display device (third comparative example) in which sub-pixels are arrayed based on the aforementioned pixel design.

In the sub-pixel arrays according to the third comparative example shown in FIG. 9, sub-pixels 9 of an identical color (for example, R) are arrayed in a single column along the vertical direction (second direction) as in the arrays shown in FIG. 2. Also, sub-pixels 10 of another identical color (for example, G) are arrayed in a single column which neighbors the array of the sub-pixels 9. Furthermore, sub-pixels 11 of still another identical color (for example, B) are arrayed in a single column which neighbors the array of the sub-pixels 10. The R, G, and B sub-pixels 9, 10, and 11 in a single row define one pixel 12. As shown in FIG. 9, in the sub-pixels 9, 10, and 11, patterns of light-shielding portions 13A and 13B corresponding to (resulting from) electrodes, light-shielding portions 14 which traverse near the center to partition a region of each of the sub-pixels 9, 10, and 11 into two segment regions and correspond to (result from) electrode interconnects electrically connected to the light-shielding portions 13A and 13B corresponding to (resulting from) the electrodes, and light-shielding portions 15 corresponding to capacitors as pattern segments connected to the light-shielding portions 14 corresponding to the electrode interconnects are formed. The light-shielding portions 15 are formed since the capacitors are arranged. Hence, the light-shielding portions 15 can be expressed so that they result from the capacitors. The sub-pixel 9 and the sub-pixel 10 of the identical color, which neighbors this sub-pixel 9 in the row direction, are formed to have line-symmetric patterns. Also, the sub-pixel 10 and the sub-pixel 11 of the identical color, which neighbors this sub-pixel 10 in the row direction, are formed to have line-symmetric patterns. Furthermore, this sub-pixel 11 and the sub-pixel 9 of the identical color, which neighbors this sub-pixel 11 in the row direction, are formed to have line-symmetric patterns. In this case, when respective sub-pixels are designated by rows and columns while focusing attention only on the layout shown in FIG. 9, the sub-pixel 9 in the first row and first column and the sub-pixel 11 in the first row and third column have the same pattern. When this pattern is defined as the first pattern, a pattern of the sub-pixel 10 in the first row and second column corresponds to the second pattern. Also, the sub-pixel 9 in the second row and first column and the sub-pixel 11 in the second row and third column have the same pattern, which corresponds to the second pattern, and a pattern of the sub-pixel 10 in the second row and second column corresponds to the first pattern. In a row array of the sub-pixels 9, the first and second patterns are alternately arrayed to give a checkered pattern along columns. Also, in row arrays of the sub-pixels 10 and 11, the second and first patterns or the first and second patterns are alternately arrayed to form a checkered pattern.

In this case, letting L1 [pp] be a horizontal pitch (a lens pitch of a first direction pitch) and L2 [pp] be a vertical pitch (a lens pitch of a second direction pitch), a tilt θ of each optical aperture 3 is given by:

θ=arctan(L1/L2)

When the horizontal pitch (first direction pitch) L1=1.552 [pp] and the vertical pitch (second direction pitch) L2=9.000 [pp] are set, we have:

θ=arctan(1/5.8)

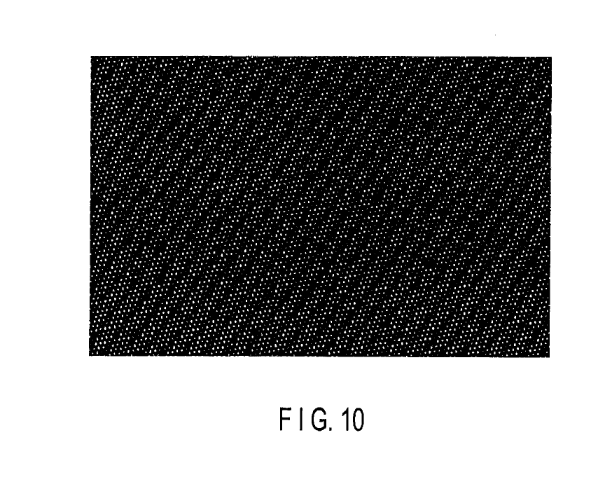

Originally, this tilt θ is one of conditions required to eliminate moiré, but moiré shown in FIG. 10 is consequently generated in a plane. Note that “pp” is a pitch of one pixel configured by three sub-pixels, and the horizontal and vertical direction pitches L1 and L2 are expressed by ratios of this pixel pitch pp.

As described above, in a sub-pixel array of a certain column (for example, an R sub-pixel array), the sub-pixels 9 of the first and second patterns are alternately laid out along the column to form, for example, a checkered pattern. Likewise, in sub-pixel arrays of other columns (for example, G and B sub-pixel arrays), the sub-pixels 10 of the second and first patterns and the sub-pixels 11 of the first and second patterns are laid out along the columns to form a checkered pattern. Upon examination of a relationship with a certain optical aperture 3 while focusing attention on one sub-pixel array, for example, a G sub-pixel array, it is simulated that moiré is generated as follows. In this case, the following description will be given while focusing attention on the G sub-pixel array. Also, the same examination applies to R and B sub-pixels.

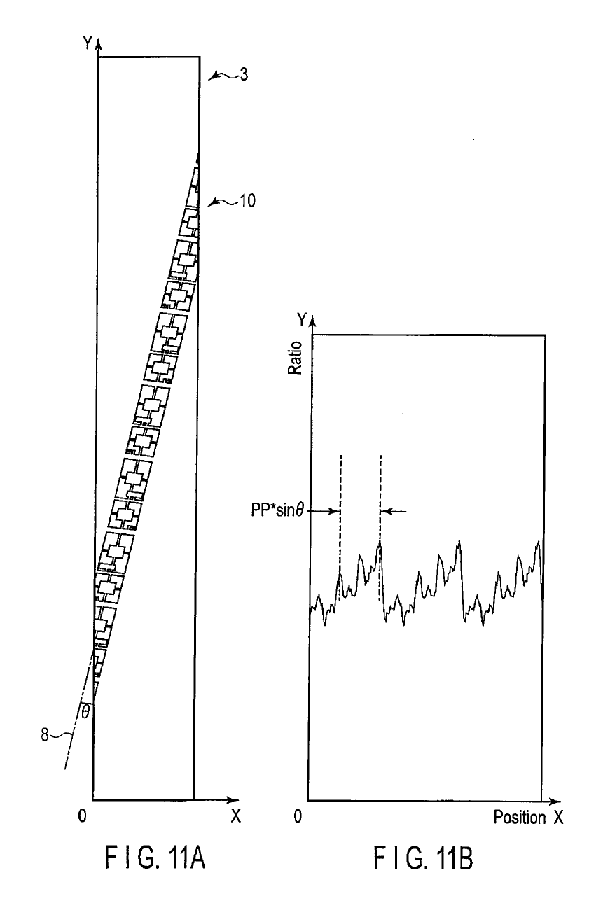

FIG. 11A illustrates a G sub-pixel array 10, which is virtually extracted and is tilted by θ, so as to simulate luminance changes when the viewing angle is changed as in FIG. 3 with reference to a major axis of one optical aperture 3. In this case, if an axis of the optical aperture 3 along itself is defined as a Y axis, and an axis perpendicular to this major axis (Y axis) is defined as an X axis, ratios each between a total height of the sub-pixel apertures 6 (a total of aperture lengths Ly) and a total height of the light-shielding portions 7 (a total of light-shielding portion lengths Sy) along this X axis are plotted on the Y axis, thus obtaining a waveform which changes periodically, as shown in FIG. 11B. In FIG. 11B, a range indicated by broken lines corresponds to a distance (pp×sin θ) obtained by converting (projecting) the pixel pitch pp as a formation interval of sub-pixels in the second direction onto the X axis. In this case, the X axis corresponds to a normal direction to the ridge 8 (Y axis) of the optical aperture 3. The total height of the sub-pixel apertures 6 represents a total of heights (distances on the Y axis) of one or more sub-pixel apertures 6 at a certain position of the normal direction (on the X axis). Likewise, the total height of the light-shielding portions 7 represents a total of heights (distances on the Y axis) of one or more light-shielding portions 7 at a position of the normal direction (on the X axis). FIG. 11B corresponds to luminance changes when the viewing angle is changed with respect to the optical aperture 3 of one sub-pixel column, as in FIG. 3, and corresponds to an intensity distribution based on changes in viewing angle shown in FIGS. 4 and 6. Actual vision of moiré is decided depending on how to sample the luminance changes via the optical apertures 3 of the ray control element.

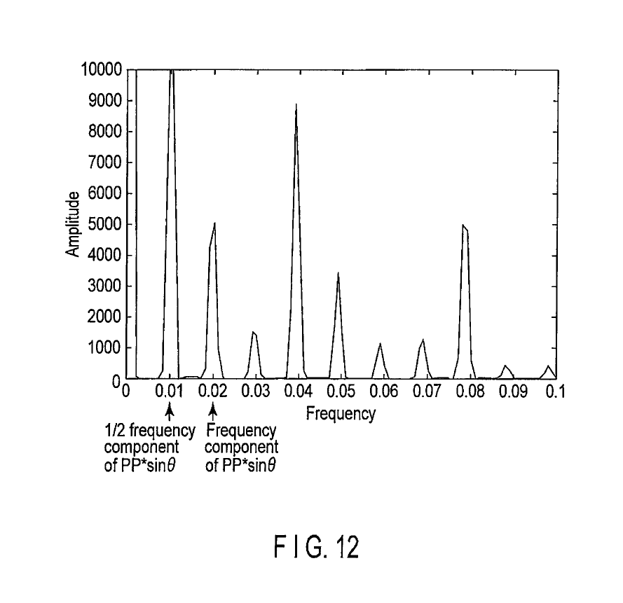

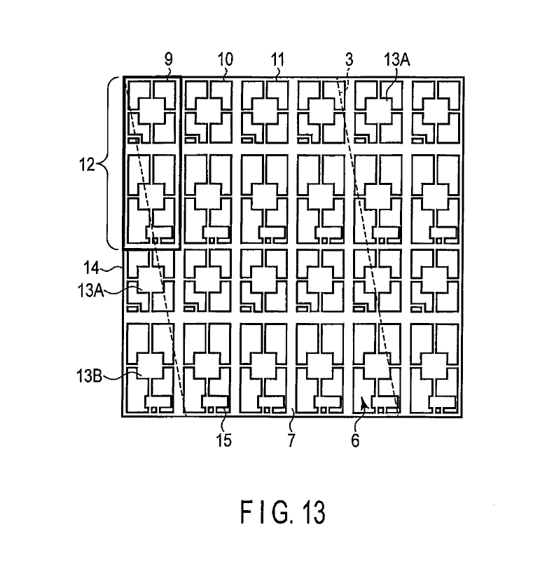

In the optical layout of the sub-pixel arrays and optical apertures 3 having such periodicities, as for information about whether or not components longer than the distance (pp×sin θ) obtained by converting pp as the formation interval of sub-pixels onto the X axis are generated, it is necessary to obtain a frequency spectra (the presence/absence and amplitudes of frequency components) shown in FIG. 12. The frequency spectra shown in FIG. 12 can be obtained from transforming ratios (corresponding to the luminance changes) of the apertures 6 to the light-shielding portions 7 shown in FIG. 11B based on Fourier transformation. As can be seen from FIG. 12 which shows the frequency component distribution, it is revealed that moiré is generated because the amplitudes of a frequency component (pp×sin θ) resulting from the sub-pixel pitch and a frequency component (pp×sin θ×½) having a lower frequency than this frequency component (pp×sin θ) are generated.

### Fourth Comparative Example

FIG. 13 shows, as the fourth comparative example, sub-pixel arrays in which a pixel 12 is configured by only sub-pixels of the first pattern shown in FIG. 9 without using any second pattern, and which do not form any checkered pattern without including any sub-pixels having the second pattern unlike in the sub-pixel arrays shown in FIG. 9.

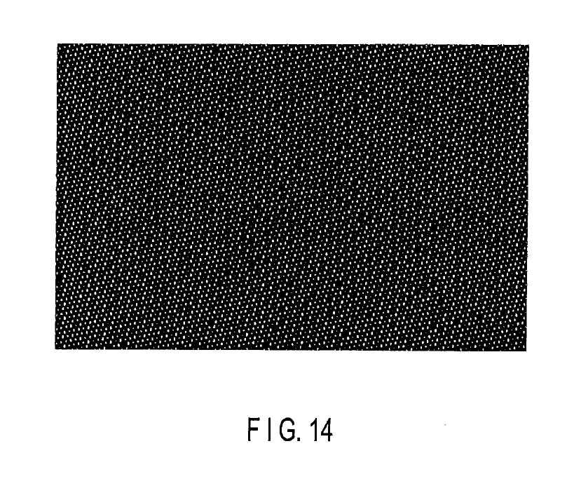

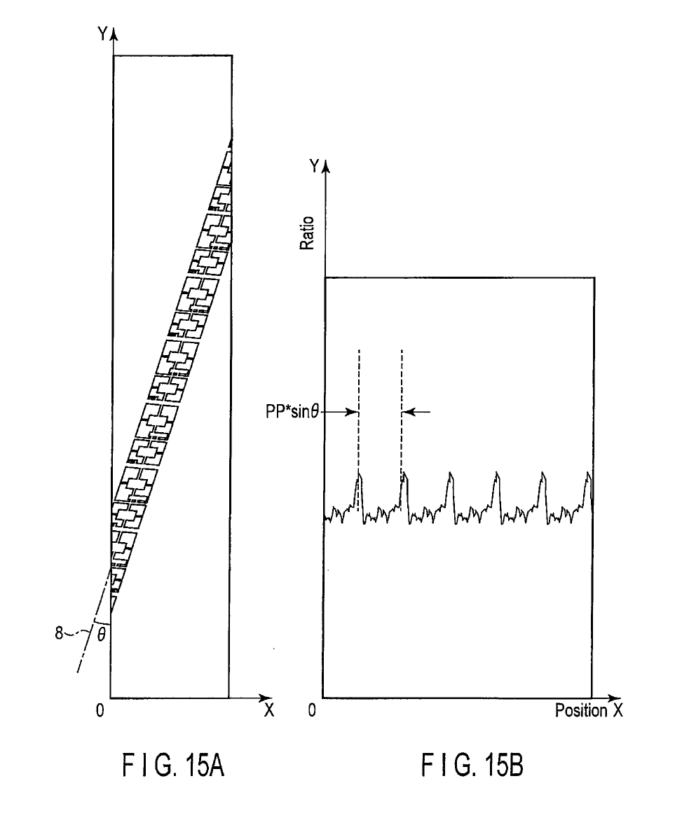

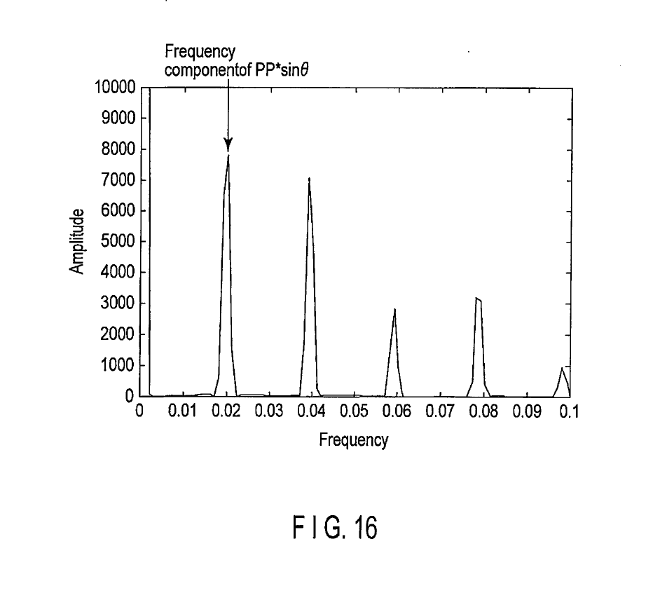

As in an optical system shown in FIG. 9, each optical aperture 3 is laid out to make the tilt θ with respect to the second direction (vertical direction). In this layout, as can be seen from FIG. 14, moiré shown in FIG. 10 is suppressed. That is, the optical apertures of the ray control element are designed to suppress moiré. In the layout shown in FIG. 13, upon calculating luminance changes when the viewing angle is changed with reference to the major axis of a certain optical aperture 3 as in FIG. 11B while focusing attention on one sub-pixel array, for example, a G sub-pixel array, as shown in FIG. 15A, a waveform which changes periodically, as shown in FIG. 15B, is obtained as in FIG. 11B. In this case, only G sub-pixels have been explained, but a waveform which changes periodically can also be obtained while focusing attention on an R or B sub-pixel array. In FIG. 15B, a range indicated by broken lines corresponds to a distance (pp×sin θ) on the X axis of one pixel. Note that the X axis corresponds to the normal direction to the ridge 8 (Y axis) of the optical aperture 3. Then, in FIG. 15B, ratios each between a total height of the sub-pixel apertures 6 (a total of aperture lengths Ly) and a total height of the light-shielding portions 7 (a total of light-shielding portion lengths Sy) are plotted on the Y axis as changes in the X direction. As can be seen from FIG. 15B, the ratios of the apertures 6 to the light-shielding portions 7 vary at periods of the distance (pp×sin θ), and the characteristics of the luminance changes shown in FIG. 15B indicate that the sub-pixels have a single shape. FIG. 15B can be transformed into frequency spectra (the presence/absence and amplitudes of frequency components) shown in FIG. 16 by Fourier transformation.

Upon comparison between FIGS. 12 and 16, the ½ frequency component (pp×sin θ×½), which is generated in FIG. 12 and results from the sub-pixels, does not appear at all in FIG. 16. Also, it is revealed that moiré generated in FIG. 10 is eliminated in FIG. 14. That is, it is apparent that the frequency component (pp×sin θ×½) having a frequency lower than the wavelength component (pp×sin θ) caused by the sub-pixels 9, 10, and 11 is generated in the luminance changes since the sub-pixels 9, 10, and 11 of two types of patterns, that is, the first and second patterns are alternately arrayed in a checkered pattern, and new moiré is caused by that frequency component.

### First Embodiment

As for aperture shapes of sub-pixels 9, 10, and 11 and a pixel 12 configured by these sub-pixels 9, 10, and 11 in the 3D image display apparatus which is designed to attain best display characteristics, shapes of sub-pixels and pixels displayed on its flat-panel display unit cannot be freely changed although moiré is generated. However, in consideration of the aforementioned examination, if the frequency characteristics of luminance changes longer than (pp×sin θ) correspond to one cause of moiré, it is possible to suppress frequency components longer than (pp×sin θ) of the luminance changes while roughly maintaining the aperture shapes of the pixels. In other words, this means that the longer frequency components of the luminance changes can be suppressed to suppress moiré even when a single pixel shape is not adopted.

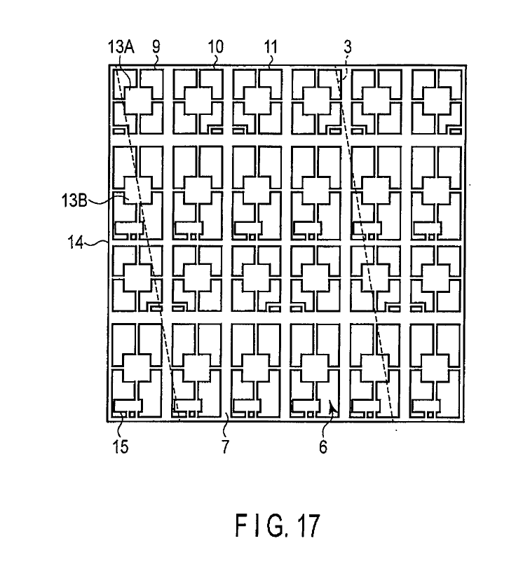

Under this examination, the present inventor focuses attention on the fact that a layout of some light-shielding portions (pattern segments) which do not influence the display characteristics even when their positions are moved can be changed, and finds that moiré can be suppressed by changing the layout. More specifically, the light-shielding portions include light-shielding portions 13A and 13B corresponding to (resulting from) electrodes, electrodes 14, light-shielding portions 15 corresponding to (resulting from) capacitors, and the like. By focusing attention on the light-shielding portions 15 corresponding to (resulting from) the capacitors as some light-shielding portions, the layout of the light-shielding portions 15 corresponding to (resulting from) the capacitors which configure pattern segments is changed, as shown in FIG. 17. In the layout shown in FIG. 17, the basic layout shown in FIG. 9 is adopted. However, the light-shielding portions (pattern segments) 15 corresponding to the capacitors of the sub-pixels 9, 10, and 11 of the first pattern are laid out at lower left positions in sub-pixel regions. Likewise, the light-shielding portions 15 corresponding to the capacitors of the sub-pixels 9, 10, and 11 of the second pattern are laid out at lower left positions in sub-pixel regions. That is, the light-shielding portions (pattern segments) 15 corresponding to the capacitors of the sub-pixels 9, 10, and 11 of the first pattern are shifted to nearly the same positions as those of the light-shielding portions (pattern segments) 15 corresponding to the capacitors of the sub-pixels 9, 10, and 11 of the second pattern. As a result of this shift, the light-shielding portions (pattern segments) 15 corresponding to the capacitors are laid out at nearly the same positions (the same relative positions in apertures) in the apertures 6 of the neighboring sub-pixels. In this case, except for the light-shielding portions (pattern segments) 15 corresponding to the capacitors, the sub-pixel 9 and the sub-pixel 10 which neighbors this sub-pixel 9 in the row direction are formed to have line-symmetric patterns. Likewise, except for the light-shielding portions (pattern segments) 15 corresponding to the capacitors, the sub-pixel 10 and the sub-pixel 11 which neighbors this sub-pixel 10 in the row direction are formed to have line-symmetric patterns. Furthermore, except for the light-shielding portions (pattern segments) 15 corresponding to the capacitors, the sub-pixel 11 and the sub-pixel 9 which neighbors this sub-pixel 11 in the row direction are formed to have line-symmetric patterns. In a single column, the sub-pixels of the first and second patterns are alternately laid out.

Note that since the display device shown in FIG. 17 has the same sub-pixel pattern shown in FIG. 9 except for the positions of the light-shielding portions (pattern segments) 15 corresponding to the capacitors, the same reference numerals denote the same parts, and a description thereof will not be given. For the layout shown in FIG. 17, please refer to a description about the layout shown in FIG. 9.

In an actual design, other changes are required. That is, upon shifting some light-shielding portions, that is, upon shifting of the light-shielding portions (pattern segments) 15 corresponding to the capacitors in the above embodiment, interconnects in the vertical directions also have to be shifted in the horizontal direction to maintain right and left area ratios in the sub-pixels. However, only a description about requirements to maintain the right and left area ratios in the sub-pixels is given, and a description about details of design items associated with such change will not be given.

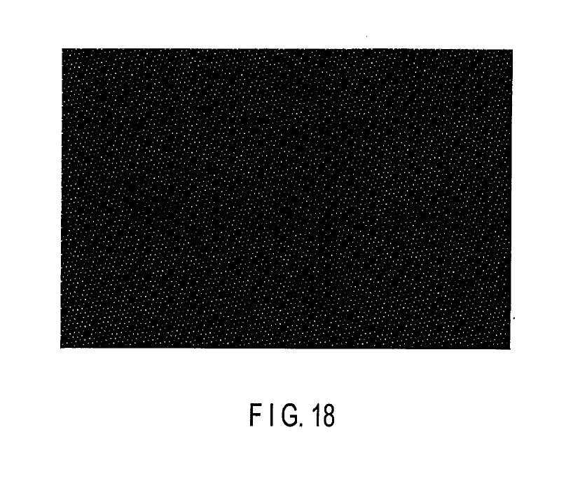

In consideration of the mechanism in which double wavelength components are generated since two types of pixels of the first and second patterns having line symmetry are adopted, as described above with reference to FIG. 9, in order to suppress double wavelength components, elements which need not be arranged symmetrically, for example, the light-shielding portions (pattern segments) 15 corresponding to the capacitors in the aforementioned embodiment are laid out at the same positions as much as possible, thus effectively suppressing moiré. As a result of such changes in layout, the amplitudes of the ½ frequency components can be largely suppressed, and moiré can be greatly suppressed, as shown in FIG. 18.

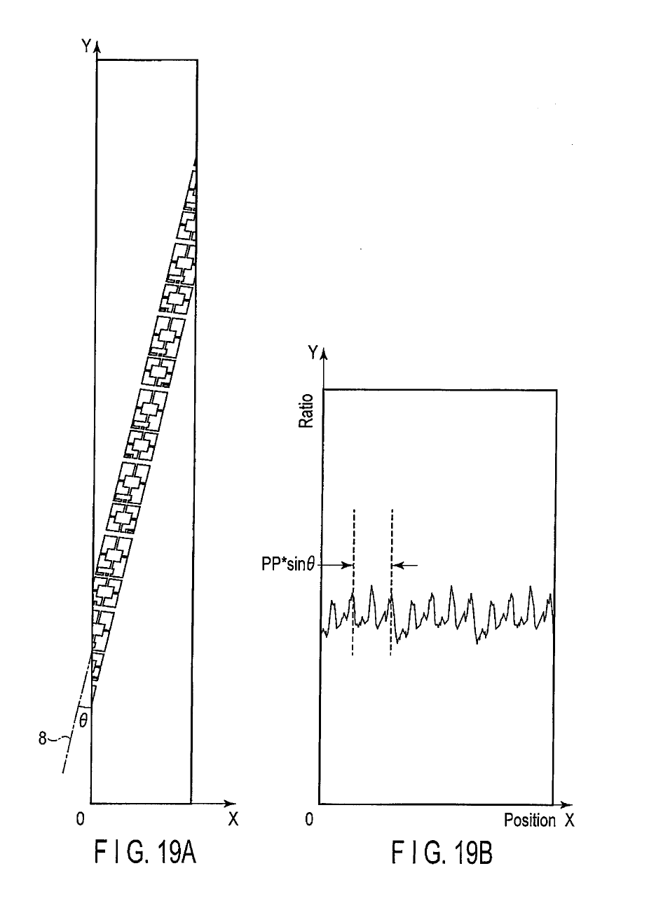

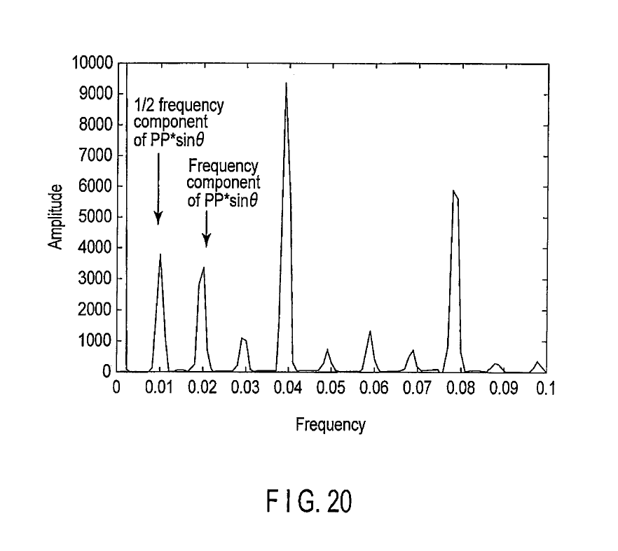

FIG. 19A shows one sub-pixel array in the pixel arrays shown in FIG. 17, for example, a G sub-pixel array, together with a certain optical aperture 3 as in FIGS. 11A and 15A. Based on this array shown in FIG. 19A, ratios each between a total height of sub-pixel apertures 6 (a total of aperture lengths Ly) and a total height of light-shielding portions 7 (a total of light-shielding portion lengths Sy) along the X axis are plotted on the Y axis, as shown in FIG. 19B, thus obtaining a waveform which changes periodically, as in FIGS. 11B and 15B. Likewise, for R and B sub-pixel arrays, waveforms which change periodically can be obtained. Then, the ratios (corresponding to luminance changes) of the apertures 6 to the light-shielding portions 7 shown in FIG. 19B are Fourier-transformed to obtain frequency spectra (the presence/absence and amplitudes of frequency components) shown in FIG. 20. As can be understood from FIG. 20, the amplitudes of a frequency component (pp×sin θ) resulting from a sub-pixel pitch, and a frequency component (pp×sin θ×½) having a frequency lower than this frequency component (pp×sin θ) are suppressed to suppress moiré. In this way, moiré caused by interferences of the ½ frequency components can be greatly suppressed, as shown in FIG. 18.

### Second Embodiment

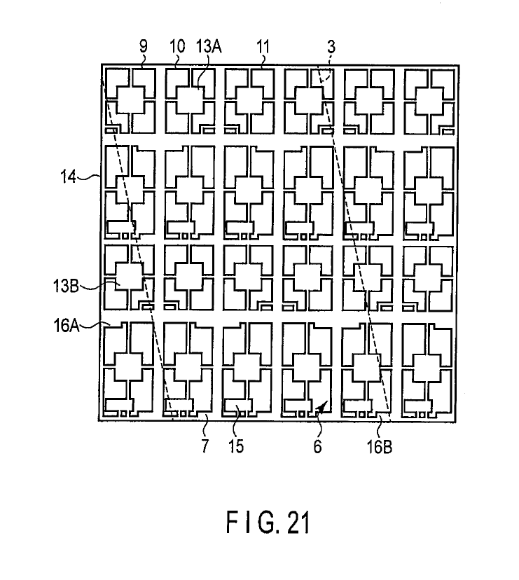

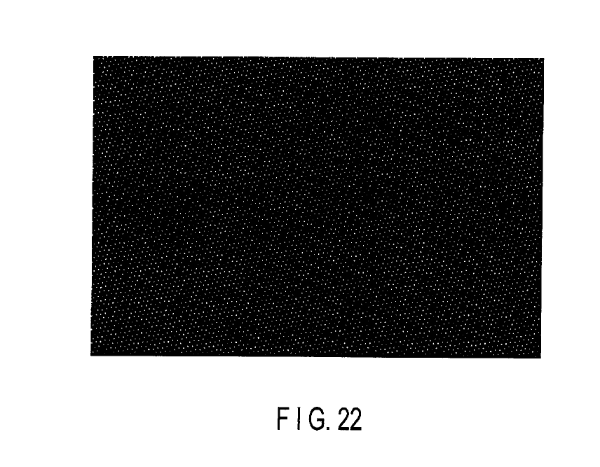

FIG. 21 shows a display device according to another embodiment, that is, the second embodiment. In the display device shown in FIG. 21, as in the sub-pixels 9, 10, and 11 shown in FIG. 17, light-shielding portions (pattern segments) 15 corresponding to capacitors as some light-shielding portions are laid out at identical positions in regions of the sub-pixels 9, 10, and 11. In addition, in order to suppress moiré more, additional light-shielding portions 16A and 16B are formed in the regions of the sub-pixels 9, 10, and 11 so as to adjust apertures 6. In other words, in pixel arrays shown in FIG. 21, sub-pixels of two types are arranged in a checkered pattern, and light-shielding portions are partially added to lose symmetry, thus changing a layout. When the light-shielding portions 16A and 16B are added to the regions of the sub-pixels 9, 10, and 11, the shapes and areas of the apertures 6 are adjusted to further suppress double wavelength components, thus more reducing moiré, as shown in FIG. 22.

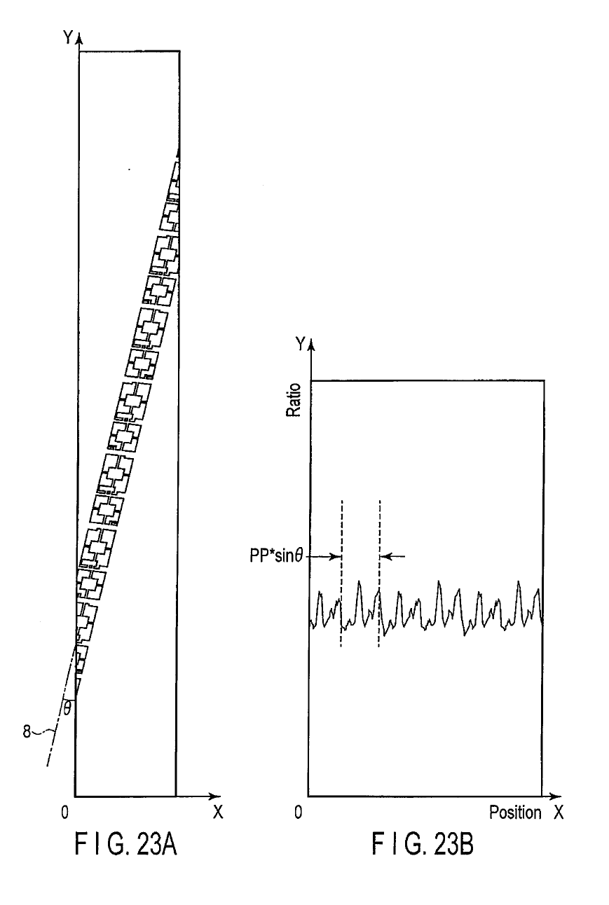

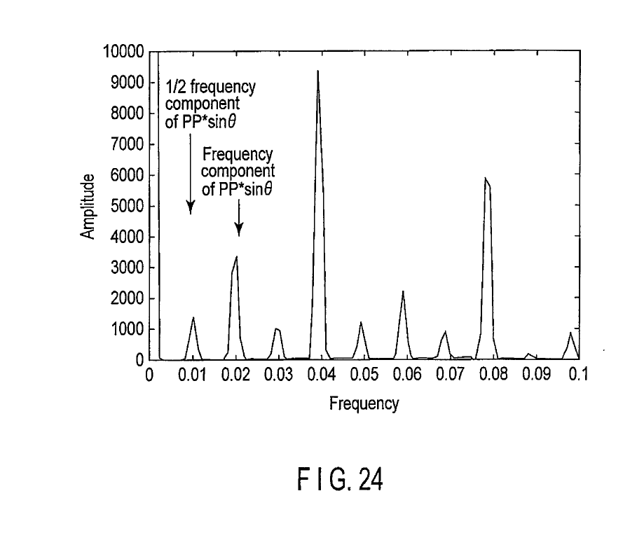

FIG. 23A shows one sub-pixel array in the pixel arrays shown in FIG. 22, for example, a G sub-pixel array, together with a certain optical aperture 3 as in FIGS. 11A, 15A, and 19A. Based on this array shown in FIG. 23A, ratios each between a total height of sub-pixel apertures 6 (a total of aperture lengths Ly) and a total height of light-shielding portions 7 (a total of light-shielding portion lengths Sy) along the X axis are plotted on the Y axis, as shown in FIG. 23B, thus obtaining a waveform which changes periodically, as in FIGS. 11B, 15B, and 19B. Likewise, for R and B sub-pixel arrays, waveforms which change periodically can be obtained. Then, the ratios (corresponding to luminance changes) of the apertures 6 to the light-shielding portions 7 shown in FIG. 23B are Fourier-transformed to obtain frequency spectra (the presence/absence and amplitudes of frequency components) shown in FIG. 24. As can be understood from FIG. 24, the amplitudes of a frequency component (pp×sin θ) resulting from a sub-pixel pitch, and a frequency component (pp×sin θ×½) having a frequency lower than this frequency component (pp×sin θ) are suppressed to more suppress moiré. In this way, ½ frequency components which cause considerable luminance changes are largely suppressed, thus reducing moiré more greatly, as shown in FIG. 22.

Irrespective of double wavelength components, suppression of the amplitudes of luminance changes can contribute to improvement of in-plane luminance uniformity. This is because the tilt control of the optical apertures 3 is to eliminate moiré by averaging luminance differences sampled by the optical apertures 3 in terms of areas, and small luminance differences themselves can broaden, for example, an adhesion error margin of a ray control element, thus providing a merit of reducing a textured impression caused by an in-plane luminance distribution.

### Third Embodiment

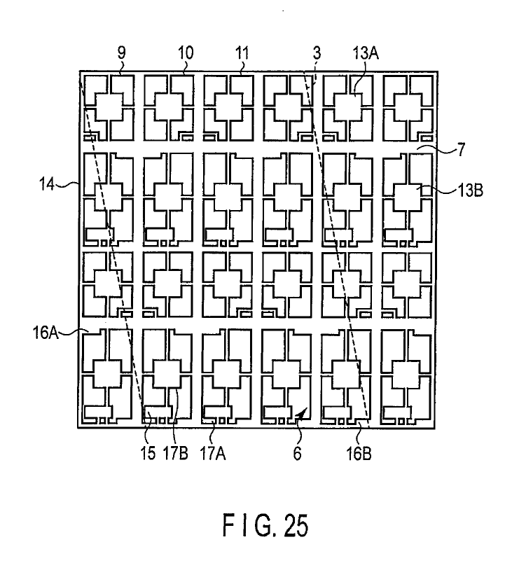

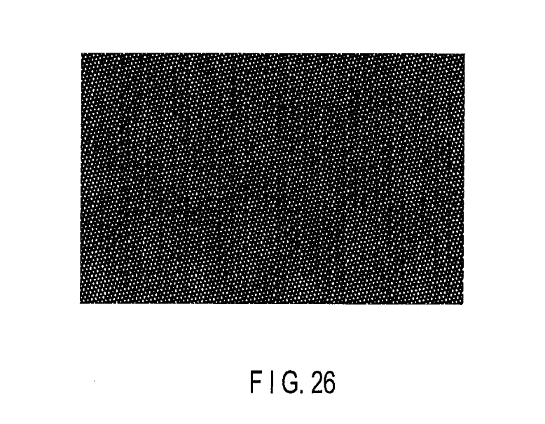

FIG. 25 shows a display device according to still another embodiment. In the display device shown in FIG. 25, as in the sub-pixels 9, 10, and 11 shown in FIG. 17, light-shielding portions (pattern segments) 15 corresponding to capacitors as some light-shielding portions are laid out at identical positions in regions of the sub-pixels 9, 10, and 11. In addition, in order to more suppress moiré, additional light-shielding portions 16A and 16B are formed in the regions of the sub-pixels 9, 10, and 11 so as to adjust apertures 6. Furthermore, other light-shielding portions 17A and 17B are added to light-shielding portions 13A corresponding to electrodes. As a result of addition of the light-shielding portions 17A and 17B to the light-shielding portions 13A corresponding to the electrodes, the light-shielding portions 13A corresponding to the electrodes shown in FIG. 25 are formed to have a rectangular shape, while the light-shielding portions 13A resulting from the electrodes shown in FIG. 21 are formed to have a square shape. In this manner, by adding the light-shielding portions 16A, 16B, 17A, and 17B at appropriate positions, frequency components on the longer frequency side as well as a frequency component (pp×sin θ) can be further suppressed. As shown in FIG. 26, an in-plane luminance distribution can be further suppressed, and generation of moiré can be suppressed.

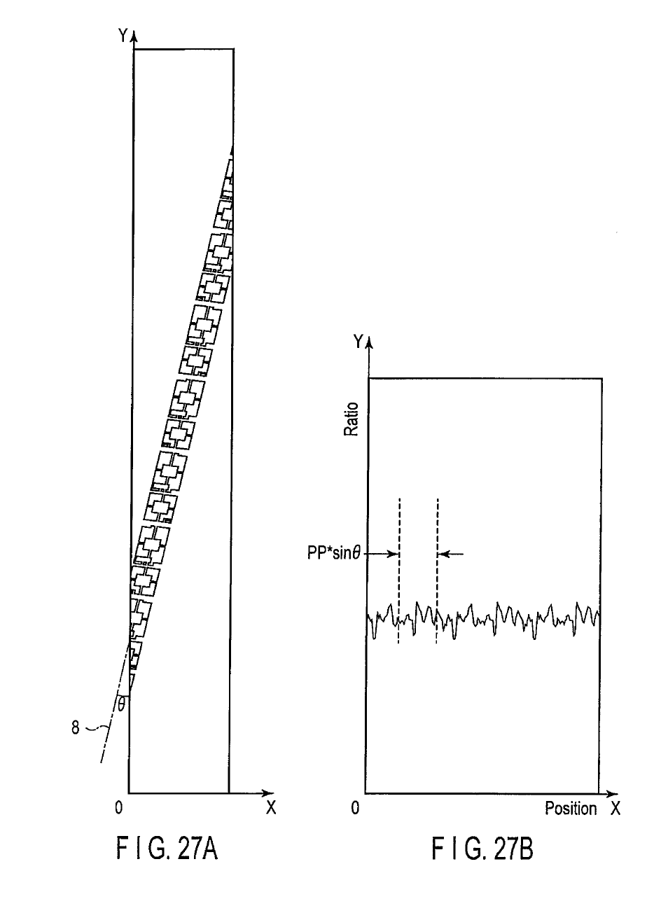

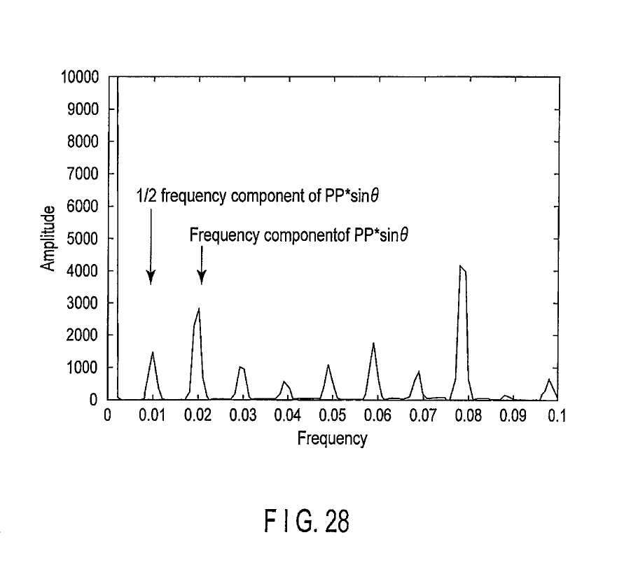

FIG. 27A shows one sub-pixel array in the pixel arrays shown in FIG. 25, for example, a G sub-pixel array, together with a certain optical aperture 3 as in FIGS. 11A, 15A, 19A, and 23A. Based on this array shown in FIG. 27A, ratios each between a total height of sub-pixel apertures 6 (a total of aperture lengths Ly) and a total height of light-shielding portions 7 (a total of light-shielding portion lengths Sy) along the X axis are plotted on the Y axis, as shown in FIG. 27B, thus obtaining a waveform which changes periodically, as in FIGS. 11B, 15B, 19B, and 23B. Likewise, for R and B sub-pixel arrays, waveforms which change periodically can be obtained. Then, the ratios (corresponding to luminance changes) of the apertures 6 to the light-shielding portions 7 shown in FIG. 27B are Fourier-transformed to obtain frequency spectra (the presence/absence and amplitudes of frequency components) shown in FIG. 28. As can be understood from FIG. 28, a frequency component (pp×sin θ) resulting from a sub-pixel pitch, and a frequency component (pp×sin θ×½) having a frequency lower than this frequency component (pp×sin θ) are reduced to suppress moiré. In this way, the amplitudes of ½ frequency components are suppressed, and variations of an in-plane luminance distribution caused by the ½ frequency components are further suppressed, thus reducing moiré more greatly, as shown in FIG. 26.

The above embodiments have explained combinations of the first and second patterns. Upon application of these embodiments, even when the first pattern may be defined as a reference pattern, the second pattern may be defined as a line-symmetric pattern to the reference pattern, a third pattern may further be defined as a point-symmetric pattern to the reference pattern, and the first, second, and third patterns are arrayed in combination, the aforementioned method is applied to each of R, G, and B colors, thus eliminating moiré.

Furthermore, when pixels of a plurality of patterns are arranged periodically, a period which results from that periodicity and is longer than a sub-pixel period is always generated. By suppressing the period longer than the sub-pixel period from luminance variations using the method described in each of the above embodiments, moiré can be suppressed.

As described above, according to this embodiment, in a 3D image display apparatus which combines a ray control element whose periodicity is limited to one direction, and a flat-panel display device, since pixel shapes are modified in addition to the tilt control of optical apertures 3, moiré can be eliminated, and image quality of 3D images can be improved.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional image display apparatus comprising:
a display unit having pixels which are arrayed in a matrix and arranged at a pitch of a pixel pp along one of a first direction and a second direction perpendicular to the first direction, wherein each pixel is configured by a plurality of sub-pixels that display different colors, each sub-pixel has an aperture that displays the color of that sub-pixel and a light-shielding portion that defines the aperture, is so formed as to have one of first and second patterns, which is defined by the aperture and the light-shielding portion, the sub-pixels of an identical color of the first pattern and the second pattern or of the second pattern and the first pattern are alternately arrayed along the second direction, and the sub-pixels are so arrayed in a matrix as to mutually give at least one of no line symmetry and no point symmetry; and
a ray control unit which is arranged to oppose the display unit, and is configured by a large number of optical apertures which are linearly extended to be tilted to form a certain angle θ with the second direction, and to be arrayed along a direction perpendicular to the extending direction.

2. The apparatus of claim 1, wherein the certain angle θ is set to be a tan(L1/L2) which is given by a ratio between a first pitch L1 along the first direction and a second pitch L2 along the second direction.

3. The apparatus of claim 1, wherein each sub-pixel has an aperture length Ly along the extending direction of each optical aperture, and a total of the aperture lengths Ly of the sub-pixels at a position along the direction perpendicular to the extending direction is changed along the direction perpendicular to the extending direction, and components of longer wavelengths than (pp·sin θ) resulting from a pitch of the sub-pixel in frequency components based on the change are suppressed.

4. The apparatus of claim 1, wherein the light-shielding portions of the sub-pixels include pattern segments which configure light-shielding portions corresponding to capacitors, layouts of the pattern segments are different in the first pattern and the second pattern, and the layouts of the pattern segments give matrix arrays which mutually give at least one of no line symmetry and no point symmetry.

5. The apparatus of claim 4, wherein in the neighboring sub-pixels, the pattern segments which configure the light-shielding portions corresponding to the capacitors are located at identical positions in the apertures.

6. The apparatus of claim 3, wherein the light-shielding portions of the sub-pixels include pattern segments which configure light-shielding portions, the layouts of the pattern segments give matrix arrays which mutually give at least one of no line symmetry and no point symmetry, and variations of amplitudes in the frequency components based on a change of the aperture lengths Ly of the sub-pixels are suppressed.
